(19) United States
(12) Patent Application Publication
(10) Pub. No.: US 2010/0164745 A1
(43) Pub. Date: Jul. 1, 2010

(54) REMOTE CONTROL DEVICE WITH MULTIPLE ACTIVE SURFACES

(75) Inventors: Charles J. Migos, San Francisco, CA (US); David Sloo, Menlo Park, CA (US); Peter Yves-Ruland, Kronberg (DE); Fabrizio Guccione, Banwell (GB)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/493,059

(22) Filed: Jun. 26, 2009

Related U.S. Application Data
(60) Provisional application No. 61/141,173, filed on Dec. 29, 2008.

(51) Int. Cl. G08C 19/00

(52) U.S. Cl. 340/825.69

(57) ABSTRACT

A remote control unit is disclosed having multiple active surfaces. In general, the side facing upward (with respect to the direction of gravity) will be active and illuminated, and the side facing downward will be inactive and blank. The present system further includes one or more orientation/motion sensors for sensing rotation about three axes and translation along three axes. The sensor detects initial movement of the remote control unit after a dormant period, and senses which side is facing upward relative to gravity so as to allow activation of the upper side. The sensor also detects when the RC unit is turned over or otherwise tilted in any plane relative to horizontal more than a threshold angle. Once turned over or tilted beyond the threshold angle, the previously active side is deactivated and the opposite side is activated.

### CROSS-REFERENCE TO RELATED APPLICATION

The present application claims priority to provisional patent application No. 61/141,173, entitled, Remote Control Device with Multiple Active Surfaces, to Migos et al., which application was filed on Dec. 29, 2008 and which application is incorporated by reference herein in its entirety.

### BACKGROUND

Remote control units are used to control many different types of electronic components, including televisions, stereos, computers, video cameras, and video cassette recorders (VCRs). Conventional remote control units are battery powered devices with buttons that activate various operations in the controlled components. For example, a remote control (RC) unit for a television might include a power button, channel up and channel down buttons, volume buttons, and a numeric keypad.

Conventional RC units come in a variety of shapes and sizes, but in general may have a single surface that is the active surface of the device. In use, the active surface is typically held facing upward, so that a user may see the various function buttons and select the desired function button. When a user depresses a button, the RC handset emits a signal to the controlled component to cause an action associated with the depressed button. RC units are typically implemented with an infrared (IR) transmitter that transmits the command signal using IR communication. The controlled component has an IR receiver to receive and respond to the command signal by performing the desired function.

As the functionality and sophistication of controlled components have increased, the number of buttons on conventional RC units has also increased. In order to fit all of the necessary buttons on conventional RC units, such units have become large and cumbersome, and include an active surface crowded with function buttons.

Moreover, as the number of electronic components has increased in the home, for example, through the addition of video recording devices, cable television converters and stereophonic equipment, so too has the number of RC units used to control all of the individual components. Each manufacturer commonly provides a separate remote for each component. Therefore, it is common for the user to have many remotes, each remote being designed to control a particular component. While universal remote control units are known for controlling multiple devices, such remotes suffer the above-described problem of excessive size and overcrowding of buttons on the active surface.

Conventional RC units have either hard keys which can be depressed to select a given function, or a touch sensitive keypad, commonly referred to as a touch pad. Touch pad RC units use a change in capacitance or other electrical property to identify the location where the active surface is touched. A function associated with the touched location is then performed by the RC unit on the controlled device. Examples of touch pad RC units are shown in U.S. Pat. Nos. 5,237,327 and 5,353,016, each entitled “Remote Commander.”

It is also known to provide motion sensing within remote controls. For example, U.S. Pat. No. 6,346,891, entitled, “Remote Control System with Handling Sensor in Remote Control Device,” assigned to the owner of the present application, discloses a remote control including a motion sensor for detecting when the remote control is picked up. Some controlled devices require time for a start up sequence before they can respond to remote control commands. Accordingly, the motion sensor in U.S. Pat. No. 6,346,891 sends a signal upon being picked up to controlled components to initiate the start up sequence in the controlled component.

U.S. Pat. No. 6,853,308, to K. Dustin entitled, “Multi-Sided Remote Control Device,” discloses a remote control having hard, depressible buttons on two sides of the remote control. However, the controls on the two surfaces of Dustin are always active. As such, a user attempting to actuate the buttons on the upward surface may inadvertently actuate buttons on the lower surface.

### SUMMARY

Embodiments of the present system in general relate to a remote control (RC) unit having multiple active surfaces. The RC unit may control one or more different controlled components, such as for example televisions, set-top boxes, computers and other components and/or appliances. The RC unit may include a pair of opposed, planar surfaces, each of which have an LCD or LED display and a touch pad capable of receiving user input when active. In general, the side facing upward (with respect to the direction of gravity) will be active and illuminated, and the side facing downward will be inactive and blank. Having the upward facing side be the active side allows a user to easily see and trigger the controls on the RC unit while the user is holding the unit. Where conventional remote controls had to crowd those controls on a single surface and/or were large and unwieldy, the RC unit of the present system including controls on multiple sides may have a small footprint and is easy to use.

The present system further includes one or more orientation/motion sensors for sensing an orientation of the RC unit when it is initially picked up after being inactive, and for sensing linear and rotational movement of the RC unit. Such sensors may include an accelerometer capable of measuring rotation about three axes and translation along three axes. The sensor detects initial movement of the remote control unit after a dormant period, and senses which side is facing upward relative to gravity so as to allow activation of the upper side. The sensor also detects when the RC unit is turned over or otherwise tilted in any plane relative to horizontal more than a threshold angle. Once turned over or tilted beyond the threshold angle, the previously active side is deactivated and the opposite side is activated. An aesthetic feature of the present system is that an upwardly facing side may automatically switch from blank to being illuminated upon the RC unit being picked up, turned upward or moved.

### BRIEF DESCRIPTION OF THE DRAWINGS

FIG. 1 is a block diagram of a remote control unit according to the present system together with examples of components which may be controlled by the unit.

FIG. 2 is a top view of the remote control unit.

FIG. 3 is bottom view of the remote control unit.

FIG. 4 is a top view of the remote control.

FIG. 5 is bottom view of the remote control unit.

FIG. 6 is a block diagram of components of the remote control unit according to embodiments of the present system.

FIGS. 7A and 7B together present a flowchart illustrating the operation of the remote control unit according to embodiments of the present system.

### DETAILED DESCRIPTION

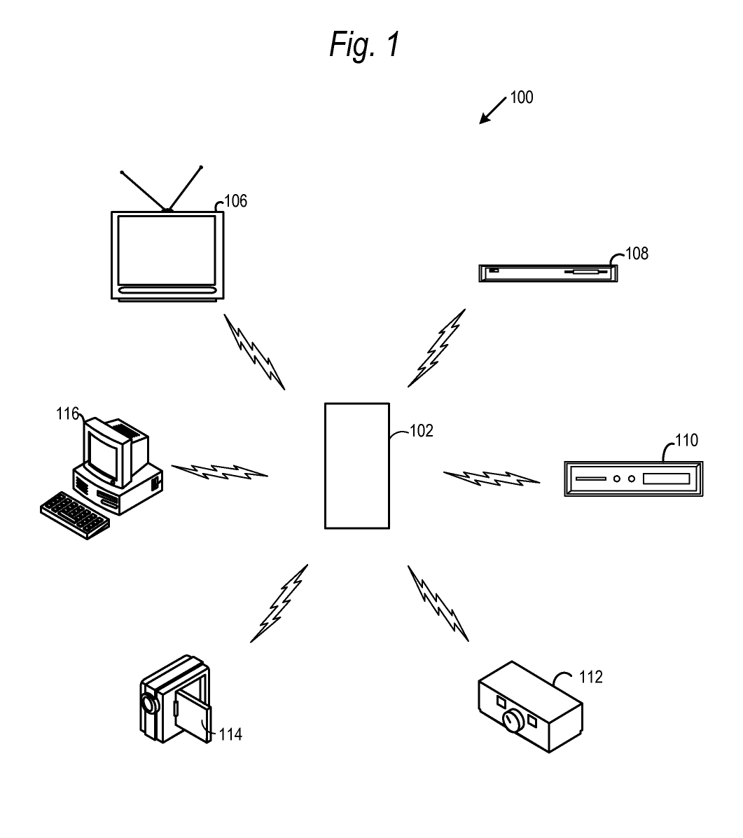

Embodiments of the present system will now be described with reference to FIGS. 1-7B, which in general relate to a remote control unit having multiple active surfaces. The respective surfaces active/deactivate by flipping or tilting the remote control unit toward the opposite surface. FIG. 1 shows a remote control system 100 having a remote control (RC) unit 102 for controlling one or more electrical components, referred to herein as controlled components. In embodiments, the RC unit 102 may control one or more different controlled components, including a television 106, a set-top box 108, a VCR/DVD player 110, a stereo 112, a video camera 114 and a computer 116. It is understood that the RC unit 102 may control other components such as lights, an HVAC (heating, ventilation and air conditioning) system and/or appliances in further embodiments.

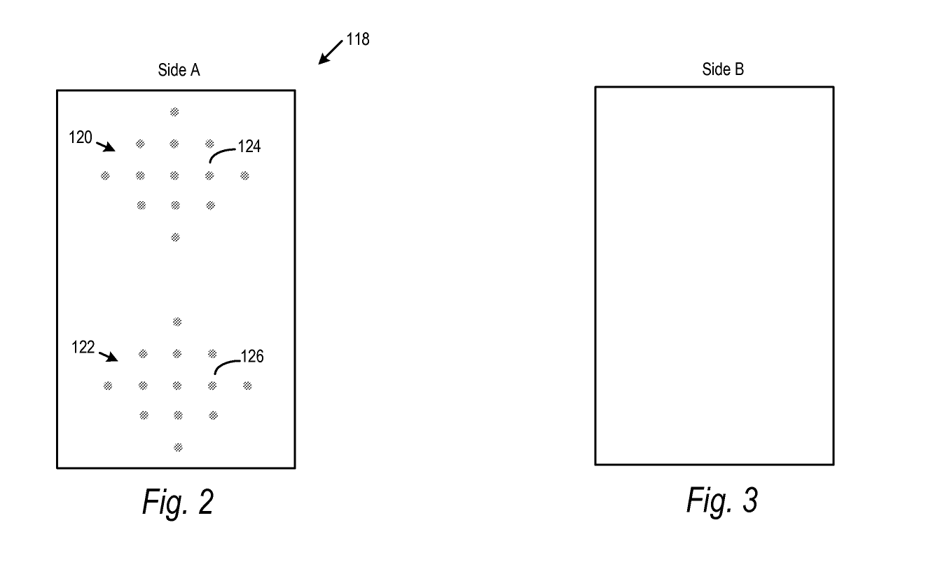

Referring now to FIGS. 2-3, the RC unit 102 may include surfaces on two opposed sides—side A and side B—of the RC unit. Both surfaces are configured to be active surfaces, though not at the same time in embodiments. In general, the side facing upward (with respect to the direction of gravity) will be active, while the side facing downward will be inactive. Having the upward facing side be the active side provides an advantage that a user may easily see and trigger the active controls on the RC unit 102 while the user is holding the unit 102 in his or her hand. However, while impractical, in an alternative embodiment, it is contemplated that the downward facing side may be active while the upward facing side is inactive. The description of sides facing upward and downward as used herein do not necessarily mean that the RC unit is in a horizontal plane perpendicular to the direction of gravity. As explained below, a side may be upward and active though it is tilted to an extent out of a horizontal plane.

FIGS. 2 and 3 are top and bottom views, respectively, of the RC unit 102 shown with side A facing upward. As seen in FIG. 2, when side A is facing upward, a user interface 118 including a variety of illuminated function indicator regions 120, 122 may be displayed on side A. Each function indicator region 120, 122 has one or more associated functions so that, if a function indicator is activated when the side A is active, the RC unit causes that function to be performed by the controlled component.

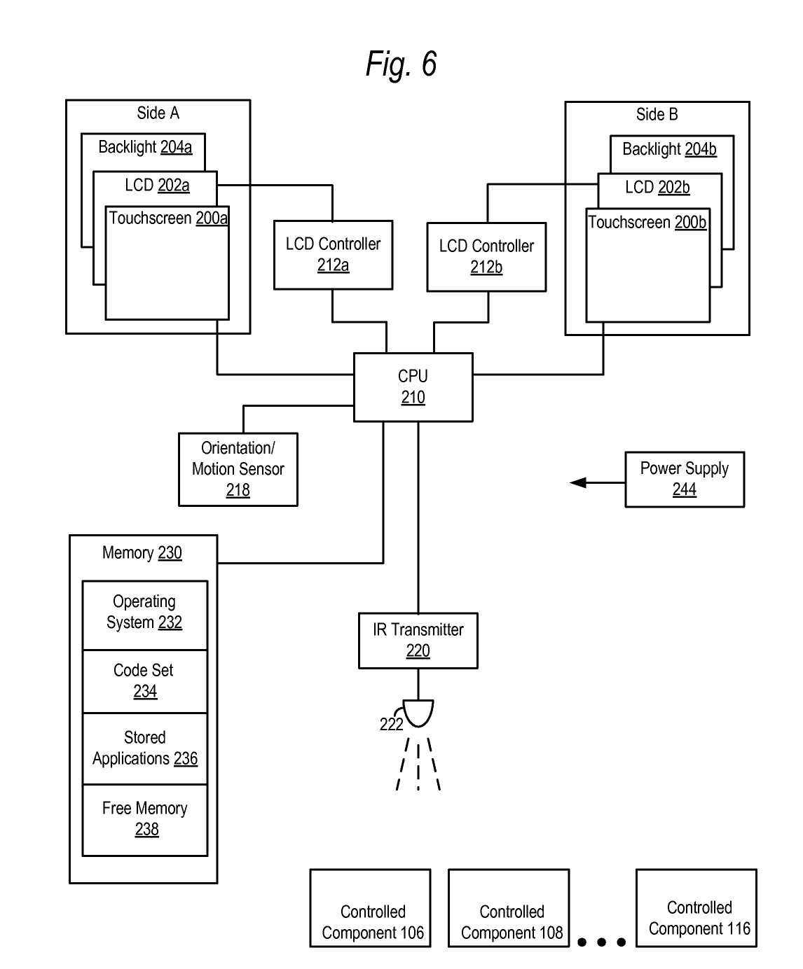

In embodiments of the present system, the side A, as well as the side B described hereinafter, is configured as a touch pad. Details regarding the components and operation of the touch pads on sides A and B are explained in greater detail below with respect to FIG. 6. However, in general, the sides A and B may be panels formed of glass, plastic, Plexiglas® or other transparent material. In further embodiments, a material that is effectively opaque may alternatively be used, but which is capable of transmitting light through variance in the material thickness. Such materials may be cut through and a light guide used to transmit the light through the opening. The panels may include conductive traces capable of sensing contact and the location of the contact. This configuration allows the RC unit 102 to have a thin profile.

When a user touches a function indicator on side A when side A is active, the RC unit 102 detects the location that was touched and the RC unit then sends a signal to the controlled component to perform the function associated with the touched function indicator. In alternative embodiments, the sides A and/or B may include depressible keys instead of a touch pad. In such embodiments, when a depressible key is actuated on an active surface, the associated function is performed on the controlled component.

The particular functions performed by the respective sides of the RC unit 102 may vary in embodiments. In one embodiment, the side A may include different function regions, each including a function indicator grid. FIG. 2 shows a pair of function regions 120 and 122 having respective function indicator grids 124 and 126, though there may be more or less regions than that in further embodiments.

Each indicator grid is capable of causing a different function to be performed on the controlled component. The indicator grid in each region 120, 122 may perform its corresponding function by dragging a finger across the indicator grid in that region. The indicator grid areas 124 and 126 may include LEDs which illuminate in sequence corresponding to a user dragging his/her finger across the grid area 124, 126. The grid areas can be used to calculate the speed at which a finger is dragged across it. The controlled component will then perform the function (volume up/down; menu scroll left/right, etc.) at the corresponding speed. Different swiping motions in a region 124 or 126 may result in different functions being performed on the controlled component. Moreover, in embodiments, if contact is maintained at the end of a finger swipe across the grid area, the device will continuously send the same command as generated by the swipe. Thus for example, in an embodiment where a user swipes his or her finger across the grid to change the channel upward, if contact is maintained at the end of a swipe, the channels will continue to scroll up until the user removes his or her finger from the user interface.

In the embodiment shown in FIGS. 2-3, side A is facing upward and is active, including the illuminated function indicators described above. While side A is active, side B may be inactive. FIG. 3 illustrates an embodiment of the appearance of side B while side A is active. In particular, there are no function indicators illuminated. In further embodiments, instead of being blank, the function indicators in side B may be illuminated even though they are inactive.

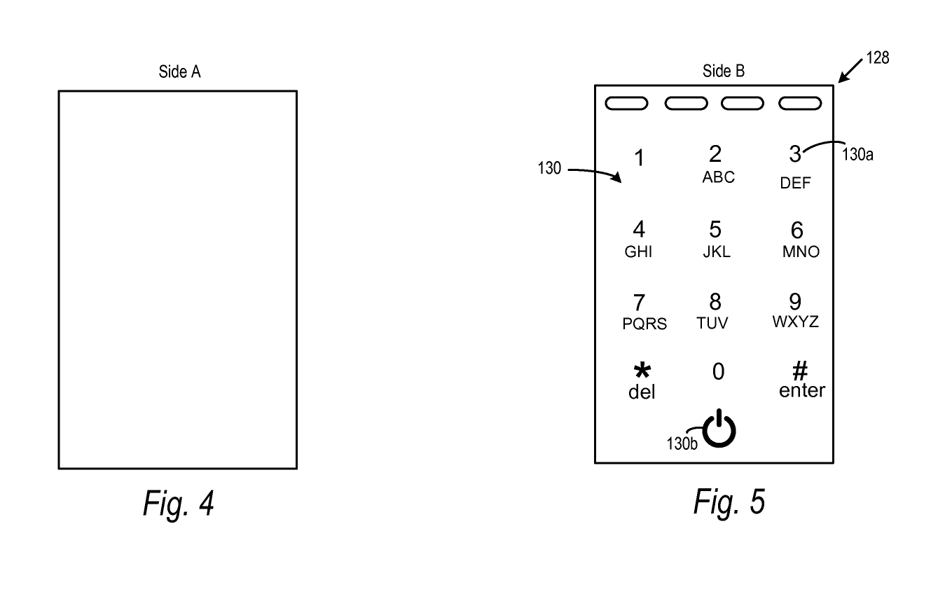

FIGS. 4-5 show the RC unit 102 with the side B facing upward and active, and the side A facing downward and inactive. FIG. 4 is a bottom view of side A when inactive, illustrating that no function indicators are illuminated. In further embodiments, instead of being blank, the function indicators in side A may be illuminated even though they are inactive. FIG. 5 shows an embodiment of side B when facing upward and active. When facing upward and active, a user interface 128 may be displayed on side B including a variety of illuminated function indicators 130. Function indicators 130 may include a keypad 130a, used for example to change channels on a television, set top box, or in other instances where alphanumerical input is required. Indicators 130 may further include on/off switch 130b for powering a controlled component on and off. The particular function indicators 130 shown on side B in FIG. 5, and their arrangement, are by way of example only, and may vary in alternative embodiments.

The sides A and B together may include controls for all functions of a controlled device. Where conventional remote controls had to crowd those controls on a single surface and/or were large and unwieldy, the RC unit 102 including controls on multiple sides may have a small footprint and is easy to use. While embodiments of the RC unit 102 include two active surfaces, it is contemplated that the RC unit include more than two active surfaces in alternative embodiments. In such alternative embodiments, orientation/motion sensors, explained below, may be provided to sense which surface is facing upward, and make that surface active while other surfaces are inactive.

FIG. 6 is a block diagram of the functional components making up an embodiment of the RC unit 102. The touch pads on each of sides A and B are composed of touch screens 200a and 200b used to sense contact with the respective sides A and B. While a variety of technologies are known for touch screens, in one embodiment, each touch screen may include a glass panel (or other translucent material) behind or within which is printed conductive traces of an electronic circuit for sensing contact. The traces may be formed for example of an electrically conductive, transparent lacquer. As is known, the circuit may operate by sensing a change in capacitance resulting from contact to identify the location of contact. Other known touch screen technologies are contemplated.

Each of sides A and B further includes an LCD 202a and 202b for displaying the function indicators described above. A backlight 204a, 204b is further provided on each of sides A and B to illuminate the LED function indicators when a side is active. The backlights 204a and 204 are capable of partially or fully illuminating the LCDs as described below. In embodiments, instead of LCDs, an array of LEDs, light guides and printing in the transparent covers may be used create the various indicators. In the following description, it is understood that LEDs and related components may instead be used wherever LCDs and related components are mentioned.

A central processing unit (CPU) 210 implements the software controlled functions of the RC unit 102. In one embodiment, the CPU 210 is a 16-bit or 32-bit processor although this may vary in further embodiments. The CPU 210 is coupled to a pair of LCD controllers 212a and 212b that are in turn coupled to LCD displays 202a and 202b. The CPU 210 provides signals to the LCD controllers 212a, 212b so that the function indicators may be displayed on side A or side B, depending on which side is active. Although not shown in FIGS. 2-5, it is further contemplated that CPU 210 can display text on the active side A or B. The CPU 210 is further coupled to the touch screens 200a and 200b. Upon sensing contact on an active surface, the CPU identifies the function associated with the contacted position (if any), and sends a function command to the controlled component. RC unit 102 can be used to control one or more controlled components 106-116 shown in FIG. 1 (or others).

The processor may include a clock capable of measuring and counting down predetermined time periods. For example, as explained below, when a side A or B is active, the processor counts down a predetermined period of time. If no motion is detected during that predetermined countdown period, the active side may go inactive.

The RC unit 102 communicates with the controlled devices 106-116 via a wireless link, such as an IR link or an RF (radio frequency) link that transmits analog and/or digital signals. FIG. 6 shows an IR link including an IR transmitter 220 for transmitting to a receiver (not separately shown) in the controlled components. The transmitter 220 includes a controller (not shown) and an infrared transmitting light source 222. The transmitter controller controls operation of the light source 222 in a known manner to encode commands for the controlled components from the CPU 210. Each controlled component receiver in range of the RC unit 102 receives the transmitted infrared signals; however, only the intended controlled component responds to the encoded transmitted signal to perform the required action.

Memory 230 is also coupled to the CPU 210. In the embodiment illustrated, the memory 230 stores an operating system software 232 that controls the basic functionality of the RC unit 102, e.g., interaction of the user with the user interfaces 118, 128 and the handling of feedback from the orientation/motion sensor, discussed below. The operating system 232 may also control other operating system kernel functions, for example the loading and execution program modules such as a setup program module. The memory 230 may also store a database of code sets 234 associated with various types and brands of controlled components, stored programs 236 and free memory 238 used for temporary data storage during program execution. The memory 230 can be implemented as a combination of read/write memory, such as static random access memory (SRAM), and read-only memory, such as electrically programmable read only memory (EPROM).

The present system further includes one or more orientation/motion sensors 218 for sensing an orientation of the RC unit 102 when it is initially picked up after being inactive, and for sensing linear and rotational movement of the RC unit 102. Such sensors are known in the art but may include an accelerometer capable of detecting an orientation of the RC unit 102 relative to gravity, as well as linear and rotational movement of the RC unit. Any of a variety of accelerometers may be used as sensor 218, but in embodiments it may be one that is capable of measuring rotation about three axes and translation along three axes. Although it is referred to as sensor 218, the sensor 218 may include multiple accelerometers instead of a single accelerometer to accomplish such measurements. Accelerometers which may be used in the present system may be known micro-electromechanical (MEMS) systems integrated into a semiconductor chip. Other accelerometers may be used.

As explained below, when the RC unit 102 is stationary for more than a predetermined period of time, both sides of the unit 102 go inactive. Thereafter, when the RC unit is lifted or otherwise moved, the sensor 218 initially senses the orientation of the unit relative to gravity, and activates whichever of the sides is facing upward (or whichever side is facing more upward than the other). This movement to activate the upward side may be translation or rotation. In the event that the RC unit 102 is at rest on its edge (when both sides are inactive), upon lifting the RC unit, the operating system may wait until the unit is tilted so that one side is facing more upward than the other. At that point, the more upwardly facing side may be activated.

If the RC unit is turned over to the opposite side, or otherwise rotated in any plane relative to horizontal more than a threshold angle, the sensor detects this rotation and signals the processor. The processor in turn deactivates the formerly upright side and activates the opposite side. Thus, whichever side is facing upward is active and capable of receiving user input via the function indicators on the upwardly facing side.

In embodiments, the predetermined threshold angle for switching active sides may be 130°. Thus for example, if side A is active, side A will remain active if the RC unit 102 is translated in any direction or is rotated in any direction less than 130° from a horizontal plane (pure rotation in a horizontal plane, about the vertical axis, will not cause a change in which side is active). However, if side A is active, and the RC unit 102 is tilted 130° or more in any direction relative to a horizontal plane, the side A will go inactive and the side B will go active. The same is true in reverse when side B is the upwardly facing side and is active.

The predetermined threshold angle at which the active and inactive sides change may be greater or lesser than 130° in further embodiments. For example, the predetermined threshold tilt angle may be greater than 90° and less than 170° in further embodiments. These angles are by way of example, and the threshold tilt angle may vary beyond these values in further embodiments. Moreover, it is understood that other actions may cause a first side to go inactive and the second side to go active. For example, a rapid rotation of remote may cause the active and inactive sides to switch. In this embodiment, rotation at an angular velocity above a threshold velocity about any of several, or all, axes may be the mechanism by which the active/inactive sides switch. This embodiment may operate instead of or in addition to embodiments where the degree of rotation is the mechanism by which the active/inactive sides switch.

Power supply 244 is provided for powering the RC unit 102. Power supply 244 may be rechargeable or single use batteries. Power supply 244 may alternatively be solar power, in which event one or both sides A and B may further include a solar cell for charging the power supply. In further embodiments, power can be provided from household AC current.

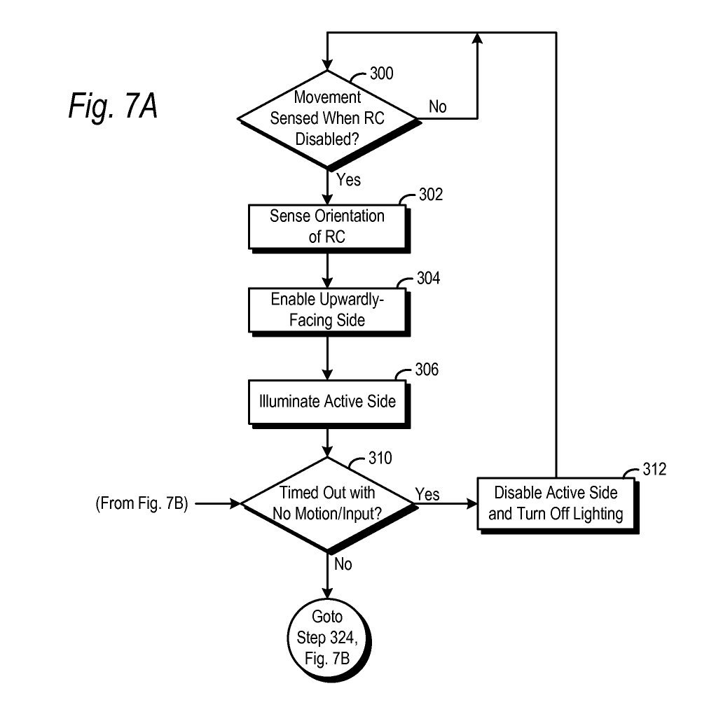

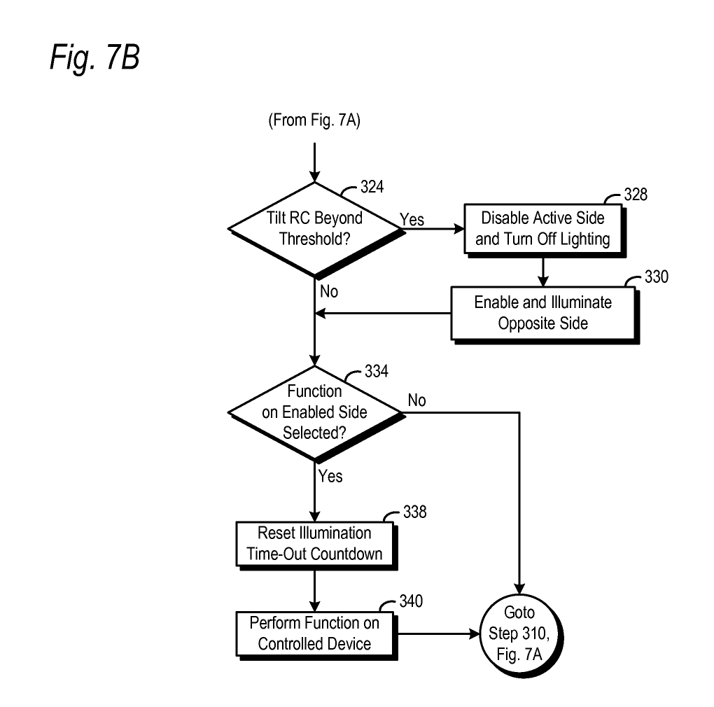

FIGS. 7A and 7B together are a flowchart illustrating the operation of the RC unit 102 according to one embodiment. In step 300, the RC unit has been stationary and unused for greater than the threshold time period, and both sides A and B are inactive. In step 300, the RC unit 102 remains dormant until the motion sensor 218 within the RC unit senses movement. If motion is sensed in step 300, the sensor 218 determines the orientation of the unit in step 302 relative to gravity. From that information, the CPU 210 determines which side is facing upward, and the operating system then activates that side in step 304. In embodiments, only the side facing upward is activated.

An aesthetic feature of the present system is that the LED on the upwardly facing side automatically illuminates when the RC unit 102 is picked up or moved. Thus, the user interface 118 or 128, which is blank when the RC unit is dormant, automatically illuminates upon moving the RC unit in step 306.

Once a side is activated and illuminated, the operating system determines if the RC unit 102 remains motionless with no user input for a predetermined threshold period of time in step 310. If so, the previously active and illuminated side is switched to inactive and goes blank in step 312. The operating system then returns to step 300 to wait for motion. In embodiments, the motionless threshold period of time may be between 5 and 15 seconds, though it is understood that this threshold period of time may be less than 5 seconds and more than 15 seconds in alternative embodiments.

If the time-out period for illumination has not yet expired in step 310, the operating system may skip down to step 324 (FIG. 7B) to see if the RC unit has been tipped to the opposite side. In step 324, the operating system determines whether the RC unit is turned over, or otherwise tilted beyond the predetermined threshold angle. As described above, if tilted beyond the threshold angle, the currently active side is deactivated and goes dark in step 328, and the opposite side is activated and partially illuminated in step 330.

In step 334, the operating system looks for selection of a function indicator (entry of a command) on an active side of the RC unit 102. If no such function has been selected, the operating system returns to step 310 (FIG. 7A) to look for expiration of the motionless threshold time period. If, on the other hand, selection of a function indicator is detected in step 334, the illumination countdown is reset to its maximum in step 338. The RC unit 102 may also send a signal in step 340 to perform the selected function on the controlled component as described above.

In each of the embodiments described above, the RC unit 102 includes at least two active surfaces, with the active surface switching, depending on which side is facing upward. In an alternative embodiment, the RC unit 102 may include a single active surface, but that active surface is capable of displaying two or more virtual active sides of the RC unit 102. That is, when the RC unit is facing upwards, a first virtual active side may be displayed (such as for example that shown and described with respect to FIG. 2). If the RC unit is then flipped over (for example at least 130°), and then flipped back, the display on the active surface may change to a second virtual active side of the unit (such as for example that shown and described with respect to FIG. 5. It will be appreciated that the block diagram shown and described above with respect to FIG. 6 may be modified for this embodiment to include only a single touch screen and display. In this embodiment, the sensors do not need to sense which side is facing upward, but rather when the unit is flipped. Upon flipping the CPU can toggle between virtual active surfaces.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed is:

1. A remote control unit for controlling a controlled component, the remote control comprising:
two or more sides capable of being active, the two or more active sides including:
a first side capable of receiving user input for controlling the controlled component; and
a second side, opposite the first side, the second side capable of receiving user input for controlling the controlled component;
wherein only one of the first and the second sides of the remote control unit are active at a given time.

2. The remote control unit of claim 1, wherein the first side is active and second side is inactive when the first side is facing upward and the remote control is moved, and wherein the second side is active and the first side is inactive when the second side is facing upward and the remote control is moved.

3. The remote control unit of claim 2, wherein the first side and second side are inactive when the remote control remains stationary for a predetermined period of time.

4. The remote control unit of claim 2, wherein the first side changes from active to inactive and the second side changes from inactive to active when the remote control is flipped over from an orientation where the first side is facing upward.

5. The remote control unit of claim 1, further comprising a user interface including a plurality of function indicator regions, wherein a swiping contact across different function indicator regions of the plurality of function indicator regions performs different functions on the controlled component.

6. The remote control unit of claim 1, further comprising a touch screen on the first and second sides, wherein, upon movement, the touch screen is illuminated on the side that is facing upward and the touch screen is dark on the side that is not facing upward.

7. The remote control unit of claim 1, wherein the first side changes from active to inactive and the second side changes from inactive to active when the remote control is turned at an angular velocity above a predetermined angular velocity.

8. The remote control unit of claim 1, wherein the controlled component is one or more of a television, a set-top box, a VCR/DVD player, a stereo, a video camera, a computer, lights, an HVAC system and a household appliance.

9. A remote control unit for controlling a controlled component, the remote control comprising:
two or more sides capable of being active, the two or more active sides including:
a first side capable of receiving user input when active for controlling the controlled component;
a second side, spaced from the first side, the second side capable of receiving user input when active for controlling the controlled component; and
sensors for determining which side is facing upward with respect to a direction of gravity, the side facing upward being active and the side facing downward being inactive.

10. The remote control unit of claim 9, further comprising a processor, the processor deactivating the active side if the remote control unit remains stationary for a predetermined period of time.

11. The remote control unit of claim 9, wherein the active side is illuminated upon being activated and prior to receiving user input after activation.

12. The remote control unit of claim 11, wherein the active side is dark after being stationary and receiving no user input for a predetermined period of time.

13. The remote control unit of claim 9, further comprising a user interface on one of the first and second sides including a numeric keypad for controlling a function of the controlled component.

14. The remote control unit of claim 9, wherein the first and second sides include touch pads for accepting user input.

15. The remote control unit of claim 9, wherein the first and second sides include depressible keys for accepting user input.

16. The remote control unit of claim 9, further comprising at least a third side on the remote control unit capable of receiving user input when active, only the side facing upward with respect to gravity being active.

17. A remote control unit for controlling a controlled component, the remote control comprising:
a first side capable of receiving user input when active for controlling the controlled component;
a second side, spaced from the first side, the second side capable of receiving user input when active for controlling the controlled component;
sensors for determining which side is facing upward with respect to a direction of gravity, the first side activating and at least partially illuminating when the first side is turned facing upward, the second side deactivating and going dark when the first side is turned facing upward, the first side deactivating and going dark when the second side is turned facing upward, and the second side activating and at least partially illuminating when the second side is turned upward;
a first user interface on the first side for receiving the user input when the first side is active, the first user interface including a plurality of function indicator regions, wherein a swiping contact across different function indicator regions of the plurality of function indicator regions performs different functions on the controlled component; and
a second user interface on the second side for receiving the user input when the second side is active, the second user interface including an alphanumeric keypad.

18. The remote control unit of claim 17, the first or second side illuminating when active and receiving user input.

19. The remote control unit of claim 17, both the first and second sides deactivating and going dark when the remote control unit is stationary for a predetermined period of time.

20. The remote control unit of claim 17, wherein different swiping contact motions across the same function indicator region of the plurality of function indicator regions perform different functions on the controlled component.
